(19) United States
(12) Patent Application Publication
(10) Pub. No.: US 2016/0031070 A1
(43) Pub. Date: Feb. 4, 2016

(54) TORQUE WRENCH

(71) Applicant: Norbar Torque Tools Ltd, Banbury (GB)

(72) Inventor: Andrew Ball, Banbury (GB)

(21) Appl. No.: 14/808,648

(22) Filed: Jul. 24, 2015

(30) Foreign Application Priority Data
Jul. 29, 2014 (GB) 1413382.1

(51) Int. Cl. B25B 23/142

(52) U.S. Cl. CPC B25B 23/1425

(57) ABSTRACT

A torque wrench comprises a head for engagement with a workpiece and a handle for applying a torque to the head. The handle comprises: a body; at least two elastic elements disposed within the body; a connector between the elastic elements; and a torque adjustment element for determining a compression of the elastic elements. The torque adjustment element is slidably engaged with the connector such that radial movement of the torque adjustment element is limited.

### CROSS-REFERENCE TO RELATED APPLICATION(S)

This application claims priority to United Kingdom Patent Application No. 1413382.1 filed on Jul. 29, 2014. Such application is hereby incorporated by reference herein, for all purposes.

### TECHNICAL FIELD

This application relates to torque wrenches, particularly but not exclusively torque wrenches which have a manual adjustment mechanism with an electronic read-out.

### BACKGROUND

Torque wrenches can be used to apply a torque to a work-piece, for example a nut or bolt. They typically contain a resistive element, e.g. a spring, which can be adjusted to apply a variable force to a breaking mechanism, which force determines the torque at which the mechanism will break to indicate that a set torque has been reached. In some types of torque wrench that have been proposed, the torque set by the user is indicated on an electronic display by means of a position sensor such as a potentiometer which determines the position of the adjusting element.

Torque wrenches are often used in safety-critical applications, where the amount of torque applied is important and so, therefore, is the user's confidence that the indicated set torque is accurately applied by the wrench.

Typically, the elastic element within a torque wrench is a spring disposed between an adjustment element, such as a setting screw or adjustment portion of the handle, used to set the level of torque to be applied, and a breaking mechanism, usually nearer to the handle end of the wrench. The Applicant has observed however that in some arrangements, due to the ratio between the radius and length of the spring, during use and especially when large torques are applied, the spring can buckle somewhat within the torque wrench body. This can cause the spring to rub against the inside of the body, causing wear and possibly producing swarf (metal shavings) and/or limiting the working life of the wrench. It may also lead to a small drop-off in accuracy over the tool's life.

Furthermore, the Applicant has recognised that if a user applies a significant amount of lateral force to a set screw or handle adjustment portion, either during setting of the torque or application of the torque to the work piece, unwanted radial movement of the adjustment element can occur. This can feel unstable to the user, and can cause a torque value shown on an electronic display to fluctuate greatly as a result of the position sensor being less able to give an accurate reading, leading to uncertainty in the level of torque being applied.

### DETAILED DESCRIPTION

The present invention aims to address the above issues, and when viewed from a first aspect provides a torque wrench comprising a head for engagement with a work-piece and a handle for applying a torque to the head, the handle comprising:
a body;
at least two elastic elements disposed within the body;
a connector between the elastic elements; and
a torque adjustment element for determining a compression of the elastic elements, said torque adjustment element being slidably engaged with the connector such that radial movement of the torque adjustment element is limited.

Thus it can be seen by those skilled in the art that by using a plurality of elastic elements connected by a connector, the individual elastic elements are reduced in length and therefore are less likely to buckle since the connector can act to provide radial support to the elastic elements. This reduces the risk of the elastic elements rubbing against the inside of the body, reducing wear.

Furthermore, as a result of the slidable engagement between the torque adjustment element and the connector, radial movement of the adjustment element is reduced as the connector can also provide radial support to that element. This reduces the problems set out previously in this regard.

In a set of embodiments, the elastic elements comprise springs, preferably compression springs, but any other form of elastic element could be used. Conveniently, but not essentially, the elastic elements are identical to one another.

In a set of embodiments, the connector has a radial size approximately equal to an inner radius of the torque wrench body and arranged to slide with respect to it. The connector is then able to move axially within the body, while radial movement of the connector is limited. This provides support to the elastic elements and the torque adjustment element.

The body is typically of circular bore and thus the connector is preferably circular. However neither of these is essential. Similarly, the adjustment element may be of circular cross-section where it engages with the connector, but this is not essential.

In a set of embodiments, the torque wrench comprises an electronic display. The display may be analogue, but in a set of embodiments it is a digital display. This display preferably shows a set torque value, determined by the compression of the elastic elements. As explained above, the advantage of increasing the radial stability of the torque adjustment element by engaging it with the connector, is particularly beneficial in the context of a wrench with an electronic display as it can increase the stability of the value shown on the digital display and prevent the displayed torque from fluctuating wildly. In such embodiments, the torque wrench preferably comprises a position sensor to determine a position of the torque adjustment element. The position sensor may comprise a potentiometer, e.g. a traditional carbon potentiometer or, preferably, a membrane potentiometer. In a set of embodiments the position sensor engages with a member coupled to the torque adjustment element, e.g. a sliding nut. For example, the position sensor may have a slider received in a recess or groove in such a member.

In a set of embodiments, the torque wrench comprises a power source for the display, for example a battery. In a set of embodiments, the battery is rechargeable, for example using a USB connector.

Typically, the torque adjustment element is a rotary adjustment element, but it may take any form of adjustment element, for example a quick adjusting ‘slider’. In a set of embodiments, the torque adjustment element comprises an adjustment screw, a sliding nut threaded onto the adjustment screw, and an adjustment locking knob. In a set of embodiments, adjustment of the torque adjustment element comprises axial movement of the sliding nut. However, it may alternatively comprise axial movement of the adjustment screw.

In a set of embodiments, the adjustment locking knob has two positions, a first in which it is free to move, and a second in which it is locked in position. The adjustment locking knob may be movable axially in order to move from the first position to the second position. Such a locking mechanism may prevent the user from accidentally changing the set torque value while torque is being applied to the work-piece.

In a set of embodiments, the connector comprises an axial hole. In these embodiments, the adjustment element may be slidably engaged with the axial hole by passing through it.

In a set of embodiments, the connector comprises axially facing grooves for receiving the elastic adjustment elements. In addition or alternatively, the connector may have a substantially conical portion, which may be used to align the elastic adjustment elements.

In a set of embodiments, the torque wrench is a click-type torque wrench.

However, it may alternatively be a different type of torque wrench which comprises an internal elastic element, for example a break-back torque wrench.

An embodiment of the invention will now be described, by way of example only, with reference to the accompanying drawings in which:

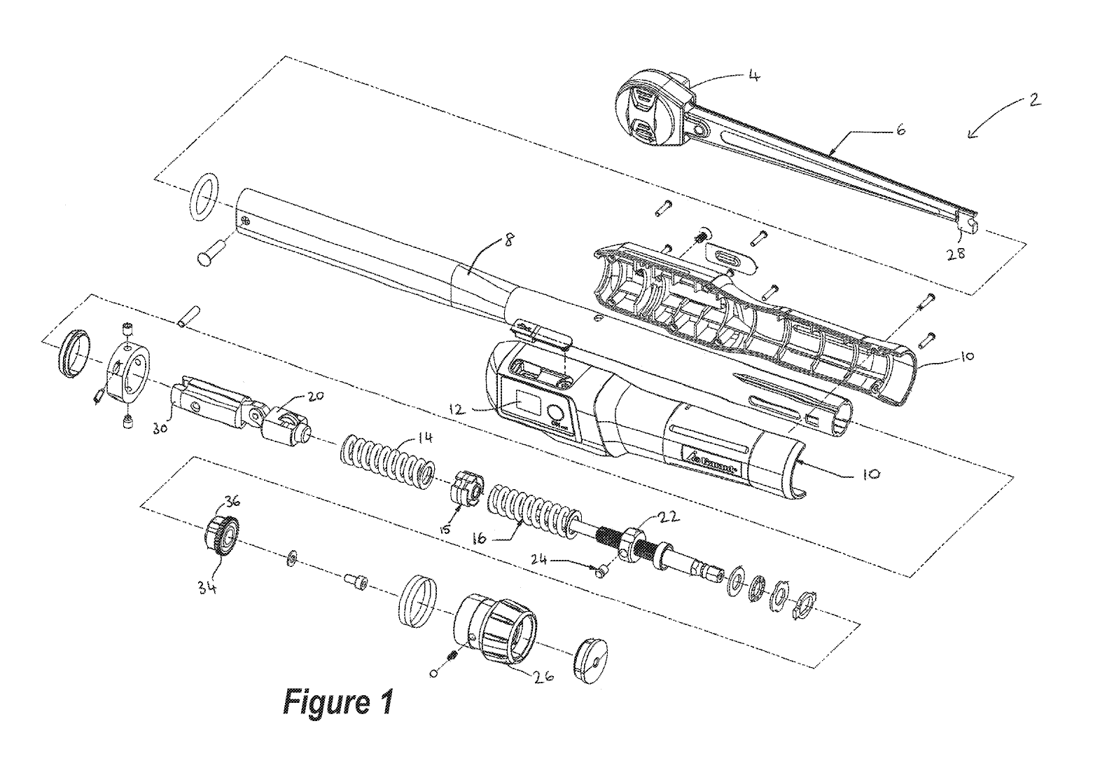

FIG. 1 shows an exploded view of a torque wrench in accordance with the invention.

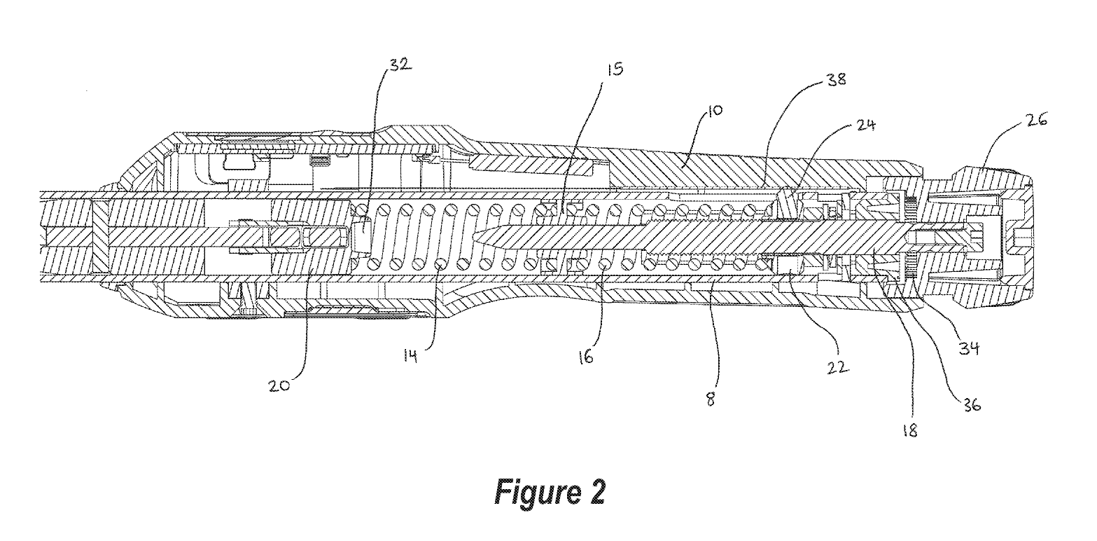

FIG. 2 shows a cross section of the torque wrench of FIG. 1.

FIG. 1 shows a torque wrench 2 in accordance with the invention. The torque wrench 2 has a head 4 for engaging with a work-piece (not shown). The head 4 is connected to a lever 6, which passes inside the body 8 of the torque wrench 2. A handle 10 is formed around the body 8, with which the user can operate the torque wrench. A digital display 12 is on one side of the handle 10.

The body 8 contains two elastic elements in the form of compression springs 14, 16, which are disposed between a torque adjustment element, in the form of a threaded adjustment screw 18, and an end piece 20. The two springs 14, 16 are coupled to one another using a connector 15 having respective axially-facing grooves for receiving the ends of the springs. As can be seen from FIG. 2, the connector 15 has substantially the same radius as the inner radius of the body 8, creating a close fit between the connector 15 and the body 8. This helps to constrain the movement of the connector 15 to being axial along the body 8, and substantially eliminates radial movement. The connector 15 therefore prevents the springs 14, 16 deviating too far from the axial centre of the body 8 and prevents them rubbing against the inner surface of the body 8.

The end piece 20 is attached to the lever 6 within the body 8, with a knocker 30 being rotatably connected to the lever end 28 in known manner. A sliding nut 22 is helically engaged with the thread of the adjustment screw 18 and receives a wiper 24 for a linear membrane potentiometer 38 (see FIG. 2). The adjustment screw 18 is attached to the adjustment knob 26. As the adjustment screw 18 passes through the connector 15, it is supported radially. By restricting the radial movement of one end of the adjustment screw 18, the radial movement of the other end, and therefore of the adjustment knob 26 is also restricted. When the user turns the adjustment knob 26 in order to change the applied torque, it is more stable and therefore the value displayed on the digital display 12 fluctuates less. The portion of the adjustment screw 18 which passes through the connector 15 is not threaded and they can therefore slide relative to one another allowing for the required axial movement.

A set of teeth 34 provided on the rear of the adjustment knob 26, which engage with a locking element 36, in order to prevent rotational movement of the adjustment knob 26 when it is in the locked position.

In use the user pulls out the adjustment knob 26 to disengage the teeth 34 thereof from the locking element 36. The knob can then be rotated in order to adjust the set torque to be applied by the torque wrench 2. Rotating the adjustment knob 26 causes the sliding nut 22 to be moved along the adjustment screw 18. This compresses the two springs 14, 16, and also causes the wiper 24 to move relative to the membrane potentiometer 38, changing the torque value displayed on the digital display 12. The springs 14, 16 apply force to the end portion 20, determining the torque needed to move the knocker 30 relative to the lever end 28. The knob 26 can then be pushed back in to lock it in place.

As the user pushes on the handle 10 to apply force, the knocker 30 and lever end 28 rotate until the desired torque has been reached. At this point, the force from the springs 14, 16 is overcome, and the knocker 30 slips relative to the lever end 28, providing the customary click indicating that the desired torque has been reached.

Although the invention has been shown in the context of a particular torque wrench, it will be appreciated that it may equally be applied to wrenches having different constructions such as those in which a portion of the handle is rotatable to set the torque. It may also be used with other wrench types such as break-back wrenches as well as the clicker type shown herein.

1. A torque wrench comprising a head for engagement with a workpiece and a handle for applying a torque to the head, the handle comprising:
a body;
at least two elastic elements disposed within the body;
a connector between the elastic elements; and
a torque adjustment element for determining a compression of the elastic elements,
said torque adjustment element being slidably engaged with the connector such that radial movement of the torque adjustment element is limited.

2. A torque wrench as claimed in claim 1 wherein the elastic elements comprise springs.

3. A torque wrench as claimed in claim 1 wherein the connector has a radial size approximately equal to an inner radius of the body and is arranged to slide with respect to the body.

4. A torque wrench as claimed in claim 1 wherein the body comprises a circular bore.

5. A torque wrench as claimed in claim 1 wherein the torque adjustment element is of circular cross-section where the torque adjustment element engages with the connector.

6. A torque wrench as claimed in claim 1 comprising an electronic display.

7. A torque wrench as claimed in claim 1 comprising a position sensor to determine a position of the torque adjustment element.

8. A torque wrench as claimed in claim 7 wherein the position sensor comprises a potentiometer.

9. A torque wrench as claimed in claim 7 wherein the position sensor engages with a member coupled to the torque adjustment element.

10. A torque wrench as claimed in claim 1 wherein the torque adjustment element is a rotary adjustment element.

11. A torque wrench as claimed in claim 1 wherein the torque adjustment element comprises an adjustment screw, a sliding nut threaded onto the adjustment screw, and an adjustment locking knob.

12. A torque wrench as claimed in claim 11 wherein adjustment of the torque adjustment element comprises axial movement of the sliding nut or axial movement of the adjustment screw.

13. A torque wrench as claimed in claim 11 wherein the adjustment locking knob has two positions, including a first position in which the adjustment locking knob is free to move, and a second position in which the adjustment locking knob is locked in position.

14. A torque wrench as claimed in 13 wherein the adjustment locking knob is movable axially in order to move from the first position to the second position.

15. A torque wrench as claimed in claim 1 wherein the connector comprises an axial hole.

16. A torque wrench as claimed in claim 15 wherein the adjustment element is slidably engaged with the axial hole by passing through the axial hole.

17. A torque wrench as claimed in claim 1 wherein the connector comprises axially facing grooves for receiving the elastic elements.

18. A torque wrench as claimed in claim 1 wherein the connector has a substantially conical portion to align the elastic elements.
